(19) United States
(12) Patent Application Publication
(10) Pub. No.: US 2025/0380679 A1
(43) Pub. Date: Dec. 18, 2025

(54) ENVIRONMENTALLY RESISTANT TACKLE BOX

(71) Applicant: Billy Donahou, Euless, TX (US)

(72) Inventor: Billy Donahou, Euless, TX (US)

(21) Appl. No.: 19/240,488

(22) Filed: Jun. 17, 2025

Related U.S. Application Data
(60) Provisional application No. 63/660,745, filed on Jun. 17, 2024.

(51) Int. Cl. A01K 97/06

(52) U.S. Cl. CPC A01K 97/06

(57) ABSTRACT

An environmentally resistant tackle box is disclosed, comprising a rigid container with an insulating foam layer and a reflective polymer layer affixed to its exterior surfaces. The insulating foam layer reduces heat transfer, while the reflective polymer layer mitigates ultraviolet (UV) light absorption, keeping the contents up to 100 degrees cooler under sunlight. Additionally, the tackle box includes an interior button-activated light for enhanced visibility during low-light conditions, such as night fishing. This design prevents damage to stored items, reduces the risk of burns to users, and improves the durability of the tackle box under prolonged environmental exposure.

### CROSS-REFERENCE TO RELATED APPLICATIONS

This application claims benefit to Provisional Application No. 63/660,745, filed Jun. 17, 2024, the contents of which are herein incorporated by reference.

### BACKGROUND OF THE INVENTION

### Field of Endeavor

The present invention relates to tackle boxes, and more particularly, to an environmentally resistant tackle box having a layer for reflecting Ultraviolet Light.

### Background of Related Art

Tackle boxes are rigid containers specifically designed for storing and organizing fishing tackles. Fishermen need constant access to their tackle boxes to change, or replace, fishing tackles while fishing. Due to the need for constant access, tackle boxes are left out in the environment, exposed to the sun, where prolonged exposure leads to damage, or destruction, of both the box and fishing tackle inside. Additionally, radiant heat from the sun heats the surfaces and components of tackle boxes, which can lead to burns, or other injuries, to a user.

As can be seen, there is a need for an environmentally resistant tackle box configured to prevent damage or injury due to sun exposure.

### SUMMARY OF THE INVENTION

In an embodiment, the present invention provides an environmentally resistant tackle box. The tackle box includes a rigid container constructed from a first shell and a second shell, the first shell and the second shell configured to cooperatively define an interior cavity for storing fishing tackle. an insulating layer is provided and affixed to at least one exterior surface of the rigid container, the insulating foam layer being configured to reduce heat transfer from environmental exposure. A reflective layer affixed to the insulating layer, the reflective layer being configured to reflect ultraviolet light. Finally, a button-activated illumination element is affixed to an interior surface of at least one of the first shell and the second shell.

In another embodiment, the present invention provides a multi-layer environmentally resistant cover. The multi-layer cover has a first insulating layer having a plurality of surfaces configured to reduce heat transfer from environmental exposure. The multi-layer cover has a second reflective layer affixed to the insulating layer, the reflective layer being configured to reflect ultraviolet light.

### BRIEF DESCRIPTION OF THE DRAWINGS

FIG. 1 is a perspective view of an environmentally resistant tackle box shown closed, according to aspects of the present invention;

FIG. 2 is a perspective view of an environmentally resistant tackle box shown open, according to aspects of the present invention;

FIG. 3 is an exploded view of an environmentally resistant tackle box shown closed, according to aspects of the present invention;

FIG. 4 is a cross-sectional view, taken along line 4-4 of FIG. 1, of an environmentally resistant tackle box, according to aspects of the present invention; and

FIG. 5 is a front elevation view of an environmentally resistant tackle box shown open, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Currently, tackle boxes are made of rigid materials and are configured to store and organize fishing tackle for quick access and use. The rigid materials include plastics and metals, which prevent damage to fishing tackle inside, but absorb Ultraviolet (UV) light from the Sun, causing a tackle box to heat up, which can cause failure of the tackle box, or its components, and/or injuries to users, such as burns.

The present invention improves on conventional tackle box design(s) by adding one or more layers configured to provide environmental resistance. The one or more layers include, but are not limited to: a foam layer, for insulation, disposed on, or affixed to one or more outer surfaces of the tackle box; and/or one or more reflective layers configured to reflect UV light, disposed on, or affixed to the foam layer.

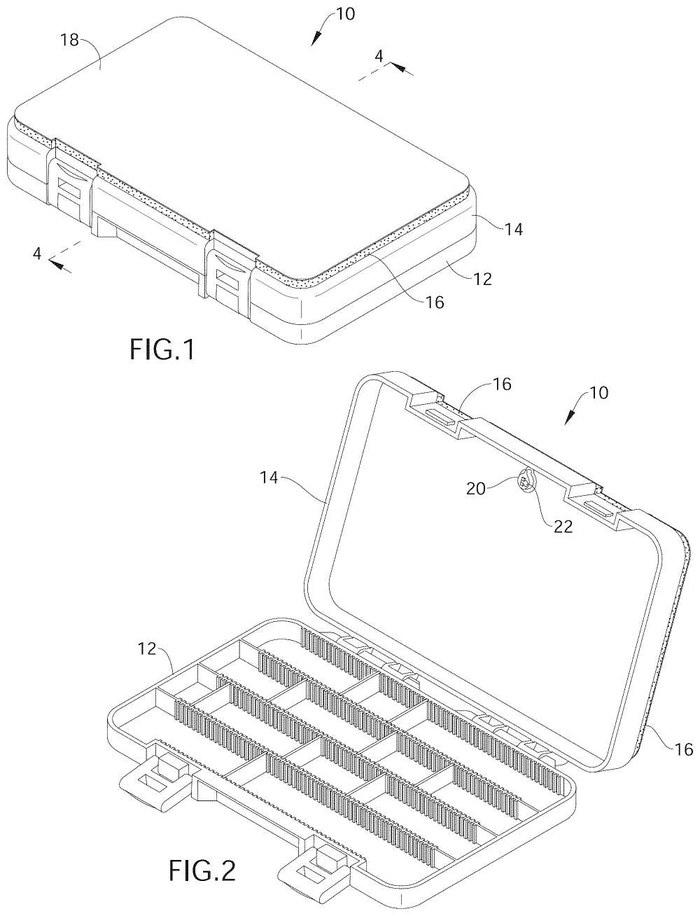

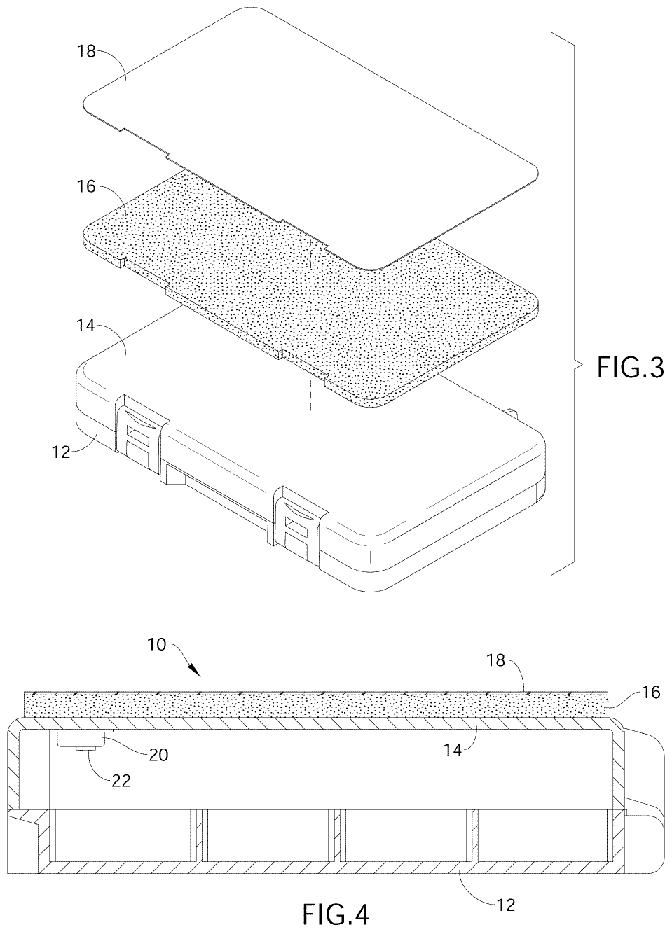

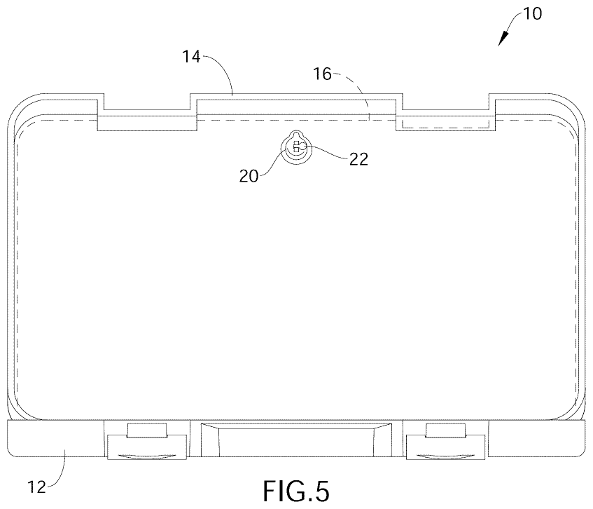

FIG. 1-5 illustrate aspects of an environmentally resistant tackle box 10, according to aspects of the present invention. Tackle box 10 is formed from at least two half shells joined by one or more hinges, and secured by one or more locking, or latching interfaces.

The at least two half shells include a first shell 12 and a second shell 14. Each of the shells is formed of one or more rigid materials, such as plastic, metal, or other materials. Specifically, the one or more rigid materials can be formed from polymers, such as Acrylonitrile Butadiene Styrene (ABS), high-density polyethylene (HDPE) or polypropylene (PP), but are not so limited. Each of the first shell 12 and the second shell 14 can be monolithically formed and include a plurality of surfaces, such as one or more interior surfaces and one or more exterior surfaces.

First shell 12 and second shell 14 are joined by one or more hinges (not labeled), or hinging apparatuses (illustrated in FIG. 2) to form a body of tackle box 10. In embodiments, the one or more hinges allow tackle box 10 to swing open from a closed configuration (illustrated in FIG. 1) to one or more open configurations (illustrated in FIG. 2). In embodiments, the one or more hinges are configured such that an angle between of an opening between first shell 12 and second shell 14 is at least 180° when fully opened. In the closed configuration, first shell 12 and second shell 14 are secured utilizing one or more locking, or latching, interfaces (not labeled), configured to secure tackle box 10 in a closed configuration (illustrated in FIG. 2).

The interior surfaces of first shell 12 and second shell 14 form a cavity, or negative space, for the storage of one or more items, such as fishing tackle (illustrated in FIG. 4). In embodiments, one or more of the interior surfaces of first shell 12 and second shell 14 includes one or more compartments, shelves, containers, etc., configured to store and organize the one or more items (illustrated in FIG. 2). Additionally, one or more of the interior surfaces of first shell 12 and second shell 14 include at least one light 20, or illuminative element, which is placed in an on or off configuration by actuating a button 22. In embodiments, light 20 is an LED light, but is not so limited. Advantageously, light 20 provides illumination for a user during times of low/no light, such as dawn, dusk and/or night fishing.

Tackle box 10 includes one or more layers configured to provide protection from the environment. In embodiments, the one or more layers include, but are not limited to, an insulating layer 16, and/or a reflective layer 18.

Insulating layer 16 is formed from insulating foam and is affixed to one or more exterior surfaces of first shell 12 and/or second shell 14, using one or more fastening means, such as glue, tape, etc. In an exemplary embodiment, insulating layer 16 is formed from ⅛-inch insulating foam and sized to cover an entirety of at least one exterior surface of first shell 12 and/or second shell 14. Reflective layer 18 is formed from a polymer, such as plastic, and is affixed to the insulating layer 16, using one or more fastening means, such as glue, tape, etc. In an exemplary embodiment, reflective layer 18 is formed from ⅛-inch plastic, which is white in color, to reflect UV rays. In the exemplary embodiment, reflective layer 18 is sized to cover an entirety of at least one surface of the insulating layer 16. Advantageously, the combination of insulating layer 16 and reflective layer 18 prevent tackle box 10 from absorbing UV light, thereby allowing tackle box 10 to maintain safer temperatures for the components of the box, the items inside, and for users contacting tackle box 10.

It should be understood, of course, that the foregoing relates to exemplary embodiments of the invention and that modifications may be made without departing from the spirit and scope of the invention as set forth in the following claims.

What is claimed is:

1. An environmentally resistant tackle box, comprising:
a rigid container, having:
a first shell and a second shell, the first shell and the second shell configured to cooperatively define an interior cavity for storing fishing tackle;
an insulating layer affixed to at least one exterior surface of the rigid container, the insulating foam layer being configured to reduce heat transfer from environmental exposure;
a reflective layer affixed to the insulating layer, the reflective layer being configured to reflect ultraviolet light; and
a button-activated illumination element affixed to an interior surface of at least one of the first shell and the second shell.

2. The environmentally resistant tackle box of claim 1, wherein the first shell is hingably affixed to the second shell.

3. The environmentally resistant tackle box of claim 1, wherein the insulating layer is formed from an insulating foam.

4. The environmentally resistant tackle box of claim 3, wherein the insulating foam is approximately ⅛-inches in thickness.

5. The environmentally resistant tackle box of claim 1, wherein the reflective layer is formed from a polymer.

6. The environmentally resistant tackle box of claim 5, wherein the polymer is one of: Acrylonitrile Butadiene Styrene (ABS), high-density polyethylene (HDPE) or polypropylene (PP).

7. A multi-layer environmentally resistant cover, comprising:
an insulating layer having a plurality of surfaces, the insulating layer configured to reduce heat transfer from environmental exposure; and
a reflective layer affixed to the insulating layer, the reflective layer being configured to reflect ultraviolet light.

8. The multi-layer environmentally resistant cover of claim 7, wherein the insulating layer is formed from an insulating foam.

9. The multi-layer environmentally resistant cover of claim 7, wherein the insulating foam is approximately ⅛-inches in thickness.

10. The multi-layer environmentally resistant cover of claim 7, wherein the reflective polymer layer is formed from a polymer.
